(19) United States
(12) Patent Application Publication
(10) Pub. No.: US 2019/0170424 A1
(43) Pub. Date: Jun. 6, 2019

(54) JET NOZZLE STRUCTURE OF IMPACT-TYPE FREEZER

(71) Applicant: Shanghai Ocean University, Shanghai (CN)

(72) Inventors: Jing XIE, Shanghai (CN); Wenjun Li, Shanghai (CN); Jinfeng Wang, Shanghai (CN); Yuyan Liu, Shanghai (CN)

(21) Appl. No.: 16/236,391

(22) Filed: Dec. 29, 2018

Related U.S. Application Data
(63) Continuation of application No. PCT/CN2017/117613, filed on Dec. 21, 2017.

(30) Foreign Application Priority Data
Dec. 1, 2017 (CN) 201711246827.0

(51) Int. Cl. F25D 17/06; F25D 23/00; A23L 3/36

(52) U.S. Cl. CPC F25D 17/06; A23L 3/001; A23L 3/361; F25D 23/006

(57) ABSTRACT

A jet nozzle structure of an impact-type freezer includes an orifice plate, a plurality of diversion channels and a plurality of jet nozzles. A plurality of circular openings in a linear arrangement are uniformly distributed in the orifice plate. The diversion channel is a hollow truncated cone including a top opening connected to the circular opening and a bottom opening connected to an inlet of the jet nozzle. The jet nozzle is a hollow cylinder and it has an outlet. A distance between two adjacent circular openings is 40-100 mm, diameter of the circular opening is 30-80 mm, and a height of the diversion channel is 20-60 mm. An inner diameter and a height of the jet nozzle are 6-15 mm and 20-40 mm, respectively. A distance between the bottom opening of the jet nozzle and a conveyor belt is 10-100 mm.

### CROSS-REFERENCE TO RELATED APPLICATIONS

This application is a continuation of International Patent Application No. PCT/CN2017/117613, filed on Dec. 21, 2017, which claims the benefit of priority from Chinese Application No. 201711246827.0, filed on Dec. 1, 2017. The contents of the aforementioned applications, including any intervening amendments thereto, are incorporated herein by reference.

### TECHNICAL FIELD

The present application relates to quick-frozen food processing machinery, and in particular to a jet nozzle structure of an impact-type freezer.

### BACKGROUND

Blast freezers are generally used in frozen food processing, and the impact-type freezer with high convective heat transfer coefficient has become the focus of freezer manufacturers and researchers. The high-speed airflow, originated from the airflow in a plenum chamber released by a nozzle structure, is critically important for a desirable impact effect. The impact effect depends largely on the structure and size of the nozzle structure. The nozzle structure of the existing impact-type freezer usually is a circular orifice plate. However, such structure leads to the problems such as low freezing rate of the frozen products in the freezing area and low uniformity during cooling process.

### SUMMARY

In order to solve the above problems, the present application at least provides a jet nozzle of an impact-type freezer.

The present application provides a jet nozzle structure of an impact-type freezer, including an orifice plate, a plurality of diversion channels and a plurality of jet nozzles. A plurality of circular openings in a linear arrangement are uniformly distributed on the orifice plate. The diversion channel is a hollow truncated cone including a top opening and a bottom opening. The top opening of the diversion channel is connected to the circular opening, and the bottom opening of the diversion channel is connected to an inlet of the jet nozzle. The jet nozzle is a hollow cylinder and it has an outlet. A distance between two adjacent circular openings is 40-100 mm. A diameter of the circular opening is 30-80 mm. A height of the diversion channel is 20-60 mm. An inner diameter of the jet nozzle is 6-15 mm, and a height of the jet nozzle is 20-40 mm. A distance between the bottom opening of the jet nozzle and a conveyor belt arranged below the jet nozzle is 10-100 mm. The distance between the two adjacent circular openings is a distance between geometric centers of two circular openings.

In an embodiment, the distance between the two adjacent circular openings is 50-80 mm; the diameter of the circular opening is 40-60 mm; the height of the diversion channel is 30-50 mm; the inner diameter of the jet nozzle is 8-12 mm and the height of the jet nozzle is 25-35 mm; and the distance between the bottom opening of the jet nozzle and the conveyor belt is 20-60 mm.

In an embodiment, the distance between the two adjacent circular openings is 60 mm; the diameter of the circular opening is 50 mm; the height of the diversion channel is 40 mm; the inner diameter of the jet nozzle is 10 mm and the height of the jet nozzle is 30 mm; and the distance between the bottom opening of the jet nozzle and the conveyor belt is 50 mm.

In an embodiment, an inner wall of the diversion channel and an inner wall of the jet nozzle are individually provided with a spiral groove.

The present invention can effectively improve the flow field uniformity in freezer during cooling of the frozen products and reduce the great difference in the cooling rate of frozen products at different freezer positions during food freezing process, therefore, the application can improve the frozen product quality.

### BRIEF DESCRIPTION OF THE DRAWINGS

FIG. 1 is a perspective view of a jet nozzle structure of an impact-type freezer according to an embodiment of the present invention.

FIG. 2 is a top view of the jet nozzle structure of an impact-type freezer according to the embodiment of the present invention.

FIG. 3 is a longitudinally cross-sectional view of the jet nozzle structure of the impact-type freezer according to the embodiment of the present invention.

### DETAILED DESCRIPTION OF EMBODIMENTS

The present invention will be further described below in conjunction with specific embodiments to make the process and features clearer.

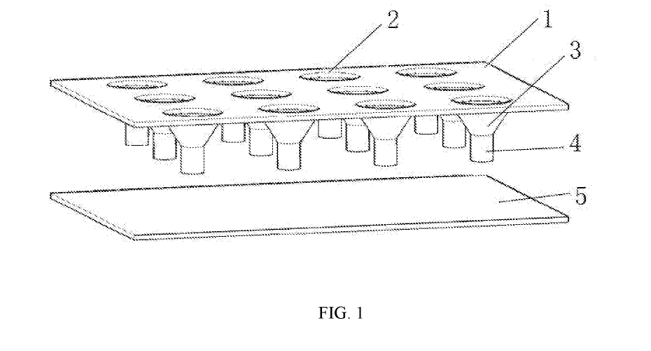

FIG. 1 illustrates an embodiment of a jet nozzle structure of an impact-type freezer. The jet nozzle structure of the impact-type freezer includes an orifice plate 1, a plurality of diversion channels 3 and a plurality of jet nozzles 4. A plurality of circular openings 2 in a linear arrangement are uniformly distributed in the orifice plate 1. The diversion channel 3 is a hollow truncated cone including a top opening and a bottom opening. The top opening of the diversion channel 3 is connected to the circular opening 2, and the bottom opening of the diversion channel 3 is connected to an inlet of the jet nozzle 4. The jet nozzle 4 is a hollow cylinder and it has an outlet 41. The low-temperature air from an evaporator is drawn by the air blower of the freezer, and then is blew into a plenum chamber. The boosted low-temperature air enters the jet nozzle via the plenum chamber. After being ejected through the nozzle, the low-temperature air cools the food which need to be frozen and then flows out of the outlet of the nozzle structure and enters the evaporator for heat transfer, and at the last is drawn into the air blower for next cycle.

The present jet nozzle structure can greatly improve the heat transfer on the surface of the conveyor belt and increase the freezing rate of the frozen products as compared to the conventional circular orifice plate structure. Meanwhile, with the significant increase of the flow rate at the nozzle outlet, the flow in the freezing area is improved, leading to the improved flow field uniformity during cooling of the frozen products and the improved quality of the frozen products.

Taking into consideration both of heat transfer effect and air blower energy consumption, the present jet nozzle structure is provided such that the heat transfer uniformity on the surface of the conveyor belt is improved at the time of minimization of the air blower energy consumption and increase of the heat transfer effect in the freezing area. Particularly, a distance between two adjacent circular openings 2 is 40-100 mm, a diameter of the circular opening 2 is 30-80 mm, and a height of the diversion channel 3 is 20-60 mm. An inner diameter of the jet nozzle 4 is 6-15 mm and a height of the jet nozzle is 20-40 mm. A distance between the bottom opening of the jet nozzle 4 and the conveyor belt 5 arranged below the jet nozzle 4 is 10-100 mm. A distance between two adjacent circular openings 2 is a distance between geometric centers of two adjacent circular openings 2.

Preferably, the distance between the two circular openings 2 is 50-80 mm; the diameter of the circular opening 2 is 40-60 mm; the height of the diversion channel 3 is 30-50 mm; the inner diameter of the jet nozzle 4 is 8-12 mm and the height of the jet nozzle 4 is 25-35 mm; the distance between the bottom opening of the jet nozzle 4 and the conveyor belt 5 is 20-60 mm.

More preferably, the distance between two adjacent circular openings 2 is 60 mm; the diameter of the circular opening 2 is 50 mm; the height of the diversion channel 3 is 40 mm; the inner diameter of the jet nozzle 4 is 10 mm and the height of the jet nozzle 4 is 30 mm; and the distance between the bottom opening of the jet nozzle 4 and the conveyor belt 5 arranged below the jet nozzle 4 is 50 mm. Preference is made based on the selection combining heat transfer intensity (i.e., Nusselt number at a surface of a heat transfer plate), heat transfer uniformity (i.e., range distribution of Nusselt number) and air blower energy consumption of the freezer.

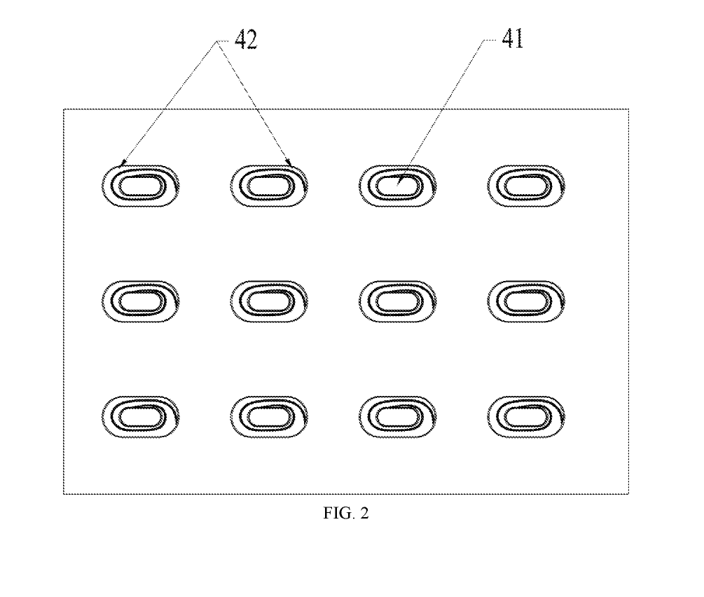

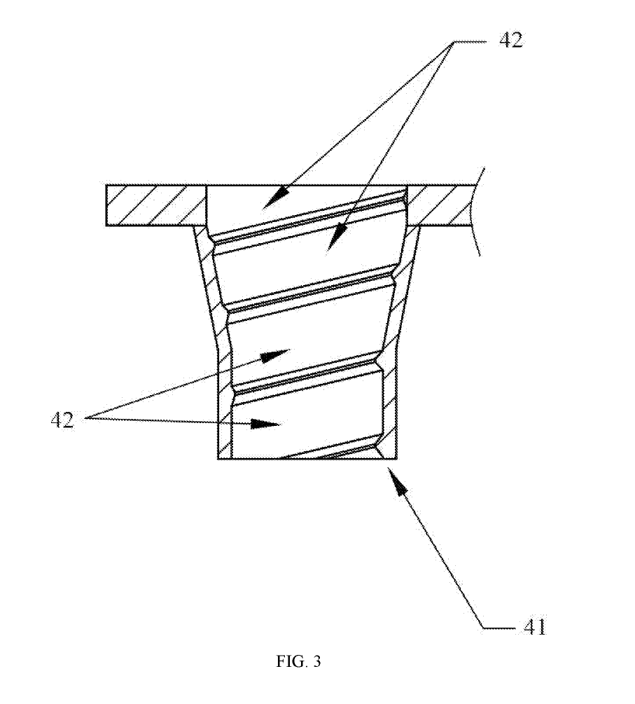

FIGS. 2-3 further illustrate the jet nozzle structure of an impact-type freezer in which an inner wall of the diversion channel 3 and an inner wall of the jet nozzle 4 are individually provided with a spiral groove 42. The spiral groove 22 enables the low-temperature air in the diversion channel 3 and the jet nozzle 4 to flow down in a spiral manner. The air still flows in a spiral manner due to inertia when ejected from the jet nozzle 4. This allows for a more uniform distribution of the compressed low-temperature air. The low-temperature air in a spiral motion even wraps around the products, especially for the products with round shapes such as eggs.

The embodiments are merely used to exemplarily illustrate but not to limit the principles and effects of the present invention. Modifications or variations to the above embodiments may be made by those skilled in the art without departing from the spirit and scope of the invention. Therefore, all of the equivalent modifications or variations also fall within the scope of the claims.

What is claimed is:

1. A jet nozzle structure of an impact-type freezer, comprising
an orifice plate;
a plurality of diversion channels; and
a plurality of jet nozzles;
wherein a plurality of circular openings in a linear arrangement are uniformly distributed in the orifice plate;
the diversion channel is a hollow truncated cone comprising a top opening and a bottom opening; the top opening of the diversion channel is connected to the circular opening, and the bottom opening of the diversion channel is connected to an inlet of the jet nozzle; the jet nozzle is a hollow cylinder;
a distance between two adjacent circular openings is 40-100 mm, a diameter of the circular opening is 30-80 mm, and a height of the diversion channel is 20-60 mm; an inner diameter of the jet nozzle is 6-15 mm and a height of the jet nozzle is 20-40 mm; a distance between the bottom opening of the jet nozzle and a conveyor belt arranged below the jet nozzle is 10-100 mm; and the distance between the two adjacent circular openings is a distance between geometric centers of two circular openings.

2. The jet nozzle structure of claim 1, wherein the distance between the two adjacent circular openings is 50-80 mm; the diameter of the circular opening is 40-60 mm; the height of the diversion channel is 30-50 mm; the inner diameter of the jet nozzle is 8-12 mm and the height of the jet nozzle is 25-35 mm; and the distance between the bottom opening of the jet nozzle and the conveyor belt arranged below the jet nozzle is 20-60 mm.

3. The jet nozzle structure of claim 2, wherein the distance between the two adjacent circular openings is 60 mm; the diameter of the circular opening is 50 mm; the height of the diversion channel is 40 mm; the inner diameter of the jet nozzle is 10 mm and the height of the jet nozzle is 30 mm; and the distance between the bottom opening of the jet nozzle and the conveyor belt arranged below the jet nozzle is 50 mm.

4. The jet nozzle structure of claim 1, wherein an inner wall of the diversion channel and an inner wall of the jet nozzle are individually provided with a spiral groove.
